(19) United States
(12) Patent Application Publication
(10) Pub. No.: US 2019/0000260 A1
(43) Pub. Date: Jan. 3, 2019

(54) Filter Kettle Structure

(71) Applicant: Jih Yang Shing Hardware Enterprise Co., Ltd., Changhua City (TW)

(72) Inventors: Chih-Wei Tseng, Changhua City (TW); Chih-Chieh Tseng, Changhua City (TW)

(21) Appl. No.: 15/637,017

(22) Filed: Jun. 29, 2017

(51) Int. Cl. A47J 31/20; A47J 31/06; A47J 31/00

(52) U.S. Cl. CPC A47J 31/20; A47J 31/00; A47J 31/005; A47J 31/06

(57) ABSTRACT

A fitter kettle structure contains: a container, a lid, and a filtering device. The container includes an opening, an outlet, and a grip handle. The lid rotatably covers the opening and includes a surround section, multiple guiding holes, and a through hole. The filtering device includes a first filter unit, a connection rod, and a second filter unit. The first filter unit is housed in the container, the connection rod inserts in the through hole and its lower end inserts into the container and connects with the first filter unit, and an upper of the connection rod extends out of the container. The second filter unit fits with the surround section so as to form an isolation space in the surround section, and the second filter unit includes an aperture and a leak-proof ring surrounding the second filter unit and matingly contacting with the container.

### BACKGROUND OF THE INVENTION

### Field of the Invention

The present invention relates to a filter kettle structure which has two-time filtration.

### Description of the Prior Art

A filter kettle is employed to brew tea and coffee, a conventional filter kettle structure contains a container and a lid, wherein the lid covers an opening of a top of the container, and the container includes a fitting sleeve fitting thereon, a grip handle connecting with the fitting sleeve, an outlet formed on the opening. The lid includes a surround portion extending to the container, multiple guiding slots defined on the surround portion, a through hole passing through the lid, and a filtering device connecting with the through hole. The filtering device has a filter mesh, a connection rod, and a pull cap, wherein the filter mesh is locked on a first end of the connection rod and is accommodated in the container, and a second end of the connection rod extends out of the through hole of the lid so as to connect with the pull cap.

However, the conventional filter kettle structure only contains the filter mesh through which fine coffee grounds flow as brewing coffee, and the fine coffee grounds exist in the coffee to influence taste. When a size of apertures of the filter mesh is reduced, the coffee grounds block the apertures of the filter mesh, thus slowing flow speed.

The present invention has arisen to mitigate and/or obviate the afore-described disadvantages.

### SUMMARY OF THE INVENTION

The primary objective of the present invention is to provide a filter kettle structure which contains a first filter unit and a second filter unit so that when brewing coffee or tea leaves, the first filter unit filters coarse coffee grounds or the tea leaves, and the second filter unit filters fine coffee grounds or the tea leaves, thus having brilliant filtration and taste at the normal flow speed.

To achieve above-mentioned objective, a filter kettle structure provided by the present invention: a container, a lid, and a filtering device.

The container includes an opening defined on a top of the container, an outlet formed beside the opening, and a grip handle fixed on an outer wall of the container.

The lid rotatably covers the opening of the container, and the lid includes a surround section extending to the container, multiple guiding holes longitudinally arranged on a peripheral wall of the surround section, and a through hole defined on a central position of the lid.

The filtering device includes a first filter unit, a connection rod, and a second filter unit.

The first filter unit is housed in the container, wherein the connection rod inserts in the through hole of the lid, and a lower end of the connection rod inserts into the container and connects with the first filter unit, hence the connection rod drives the first filter unit to move downwardly and upwardly, and an upper end of the connection rod extends out of the container.

The second filter unit fits with a lower end of the surround section of the lid so that an isolation space forms in the surround section of the lid and communicates with the multiple guiding holes, the second filter unit includes an aperture defined on a central position of the second filter unit and accommodating the connection rod, and the second filter unit includes a leak-proof ring surrounding an external rim of the second filter unit and matingly contacting with an inner wall of the container.

### BRIEF DESCRIPTION OF THE DRAWINGS

FIG. 1 is a perspective view showing the exploded components of a filtration structure of a filter kettle according to a first embodiment of the present invention.

FIG. 2 is a perspective view showing the assembly of the filter kettle structure according to the first embodiment of the present invention.

FIG. 3 is a cross sectional view showing the operation of the filter kettle structure according to the first embodiment of the present invention.

FIG. 4 is another cross sectional view showing the operation of the filter kettle structure according to the first embodiment of the present invention.

FIG. 5 is an amplified view of a portion A of FIG. 3.

FIG. 6 is a cross sectional view showing the application of the filter kettle structure according to the first embodiment of the present invention.

FIG. 7 is an amplified cross sectional view of a part of a filter kettle structure according to a second embodiment of the present invention.

FIG. 8 is a perspective view showing the exploded components of a filter kettle structure according to a third embodiment of the present invention.

FIG. 9 is a cross sectional view showing the operation of the filter kettle structure according to the third embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

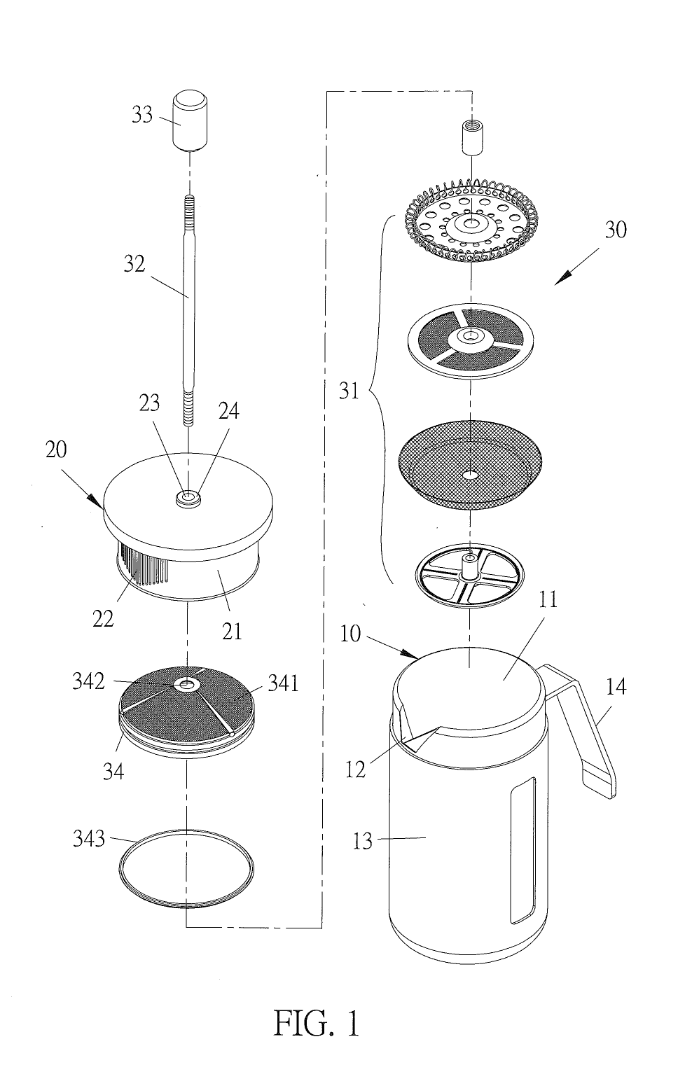

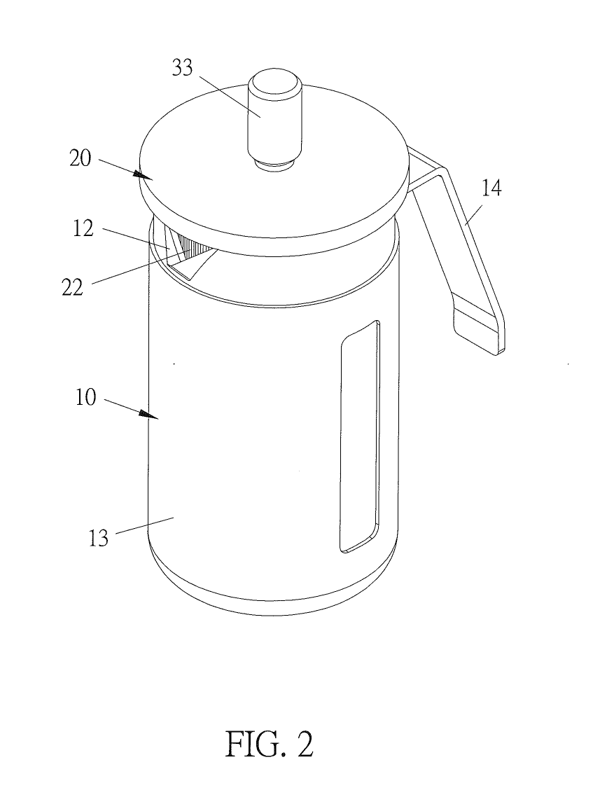

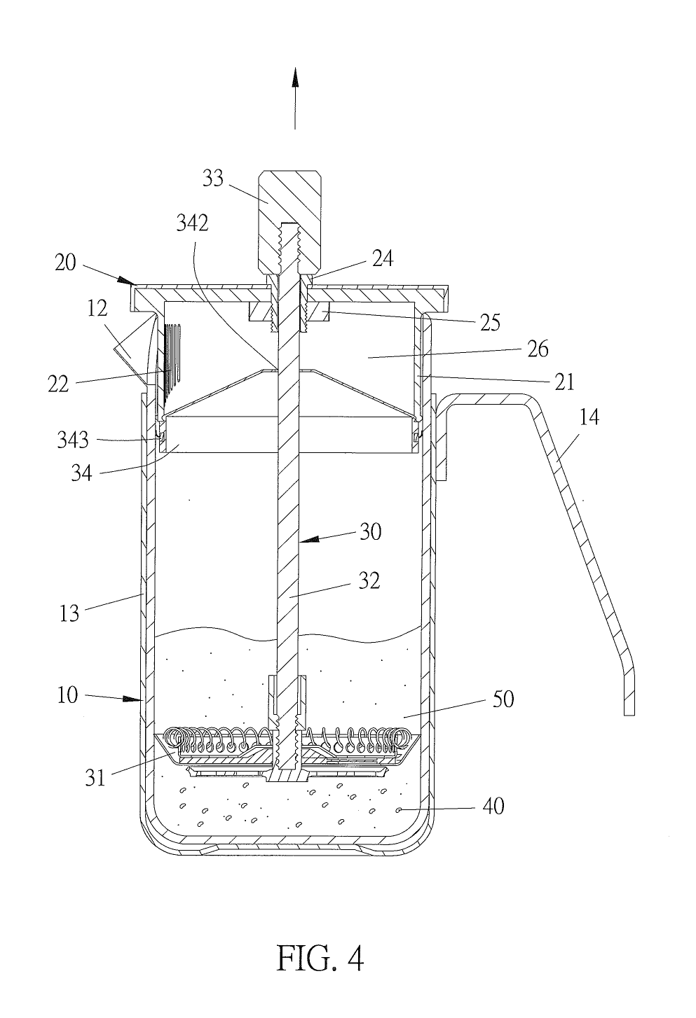

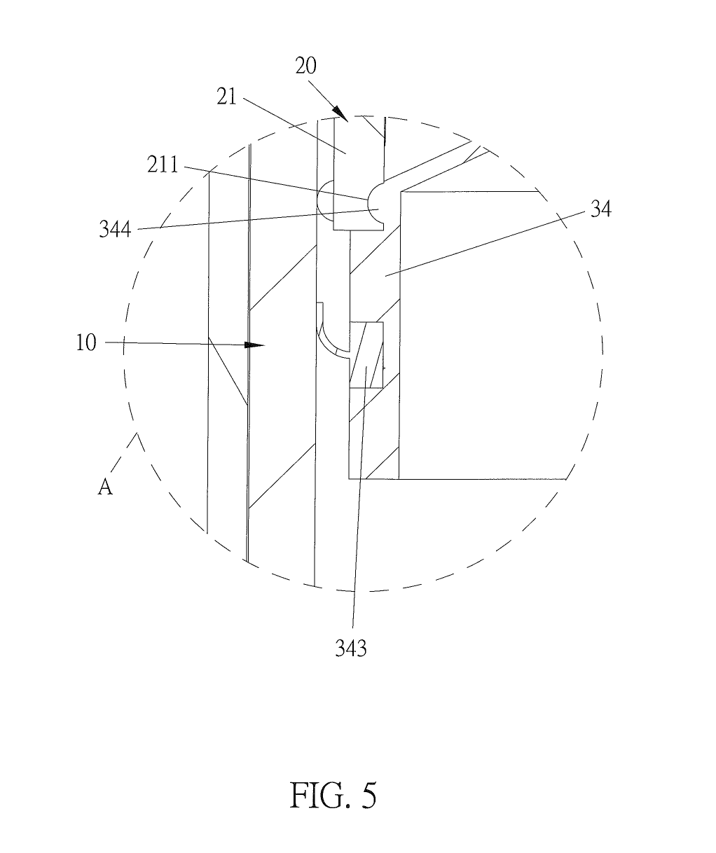

With reference to FIGS. 1-5, a filter kettle structure according to a first embodiment of the present invention comprises: a container 10, a lid 20, and a filtering device 30.

The container 10 includes an opening 11 defined on a top thereof, an outlet 21 formed beside the opening 11, a holder 13 fitted with an outer wall of the container 10, and a grip handle 14 fixed on an outer wall of the holder 13.

The lid 20 rotatably covers the opening 11 of the container 10, and the lid 20 includes a surround section 21 extending to the container 10, multiple guiding holes 22 longitudinally arranged on a peripheral wall of the surround section 21 so as to communicate with or not communicate with the outlet 12 of the container 10 by rotating the lid 20, a through hole 23 defined on a central position of the lid 20 and accommodating a bushing 24, and a nut 25 screwing with the bushing 24.

The filtering device 30 includes a first filter unit 31, a connection rod 32, a pull cap 33, and a second filter unit 34. The first filter unit 31 is in a circular disk shape and is housed in the container 10, wherein an external rim of the first filter unit 31 contacts with an inner wall of the container 10. The connection rod 32 inserts through the bushing 24 in the through hole 23 of the lid 20, and a lower end of the connection rod 32 inserts into the container 10 and connects with the first filter unit 31, hence the connection rod 32 drives the first filter unit 31 to move downwardly and upwardly. An upper end of the connection rod 32 extends out of the container 10 and screws with the pull cap 33, the second filter unit 34 fits with a lower end of the surround section 21 of the lid 20 so that an isolation space 26 forms in the surround section 21 of the lid 20 and communicates with the multiple guiding holes 22. In this embodiment, wherein an external rim of the second filter unit 34 has a convex part 344 is engaged with a concave part 211 of an internal rim of the surround section 21 of the lid 20, such as the engaging manners may a screwing manner or in other manners. The second filter unit 34 includes at least one filter mesh 341, an aperture 342 defined on a central position of the second filter unit 34 and accommodating the connection rod 32, and a leak-proof ring 343 surrounding an external rim of the second filter unit 34 and matingly contacting with the inner wall of the container 20, thus avoiding leakage.

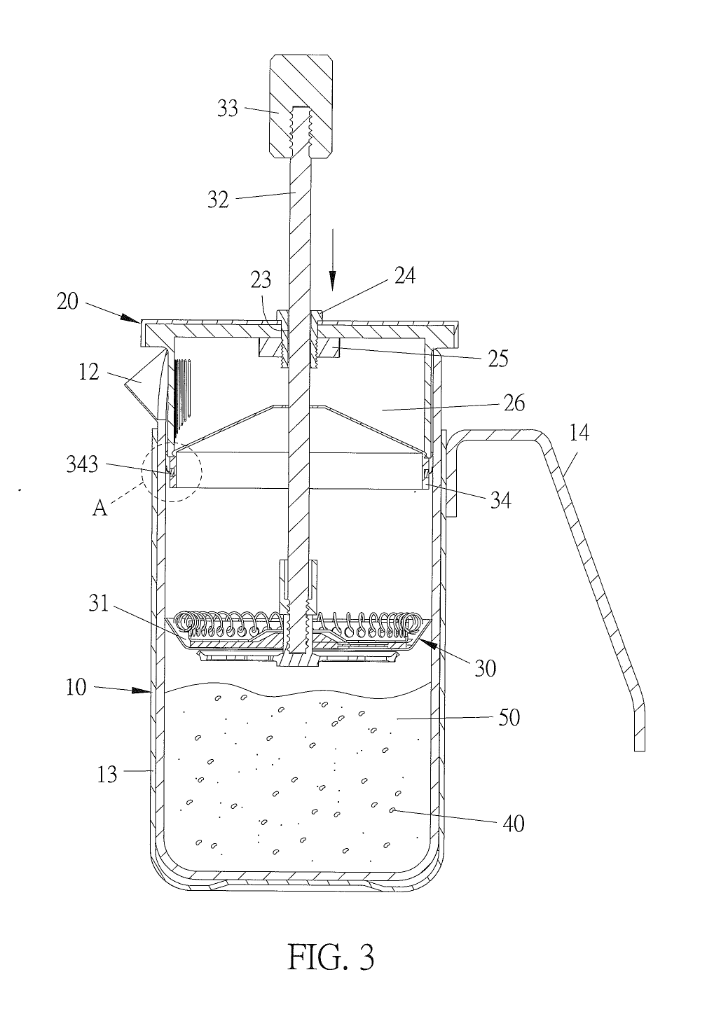

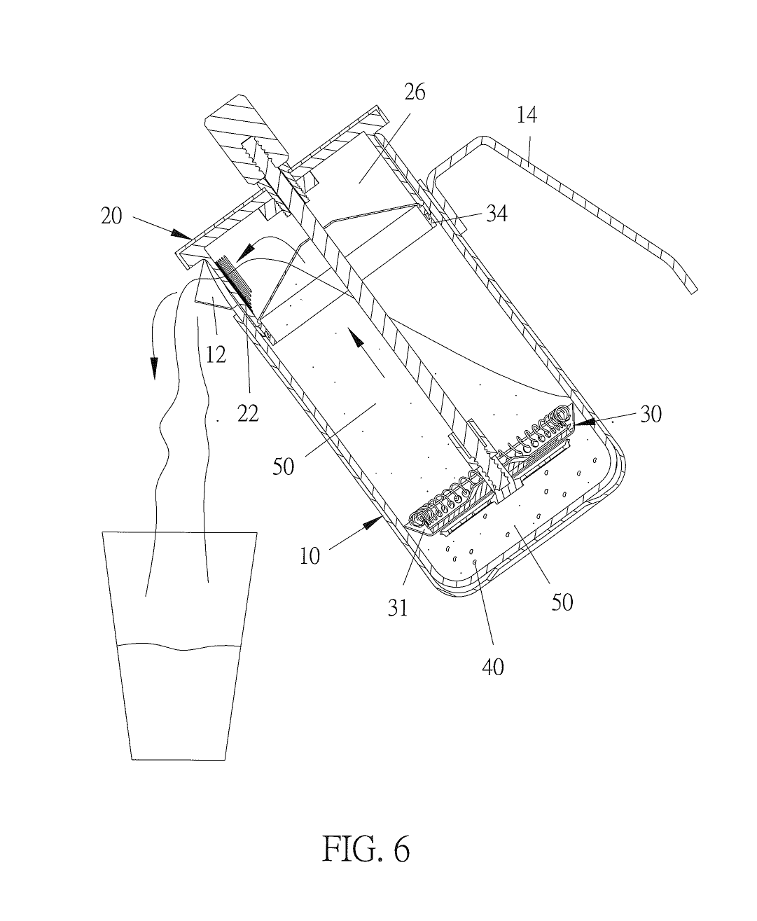

Referring to FIGS. 3, 4 and 6, as brewing coffee, ground coffee powders are put in the container 10, and boiled water is poured into the container 10 so as to brew the ground coffee powders and to extracts coffee. Thereafter, the pull cap 33 is pressed to drive the connection rod 32 to move downwardly, hence the first filter unit 31 is actuated by the connection rod 32 to descend in the container 10, wherein the first filter unit 31 stops coarse coffee grounds 40 below its lower end, and the coffee and fine coffee grounds 50 flow through the first filter unit 31, thus obtaining first-time filtration. The lid 20 is rotated that the multiple guiding holes 22 of the lid 20 align with the outlet 12 of the container 10, and the grip handle 14 is held to slant the container 10, hence the fine coffee grounds 50 of the first filter unit 31 are stopped by the at least one filter mesh 341 of the second filter unit 34 so as to obtain second-time filtration. In other words, the coffee is poured out of the outlet 12 of the container 10 via the multiple guiding holes 22 of the lid 20, after flowing into the isolation space 26 via the at least one filter mesh 341 of the second filter unit 34.

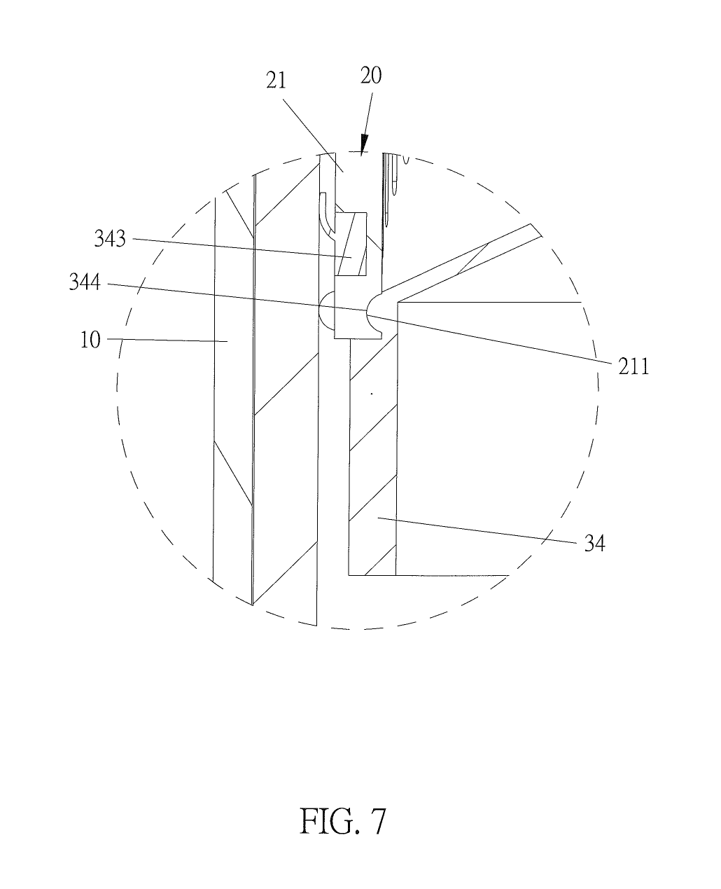

In a second embodiment, as shown in FIG. 7, the leak-proof ring 343 is arranged on the peripheral wall of the surround section 21 of the lid 20 so as to matingly contact with the inner wall of the container 10.

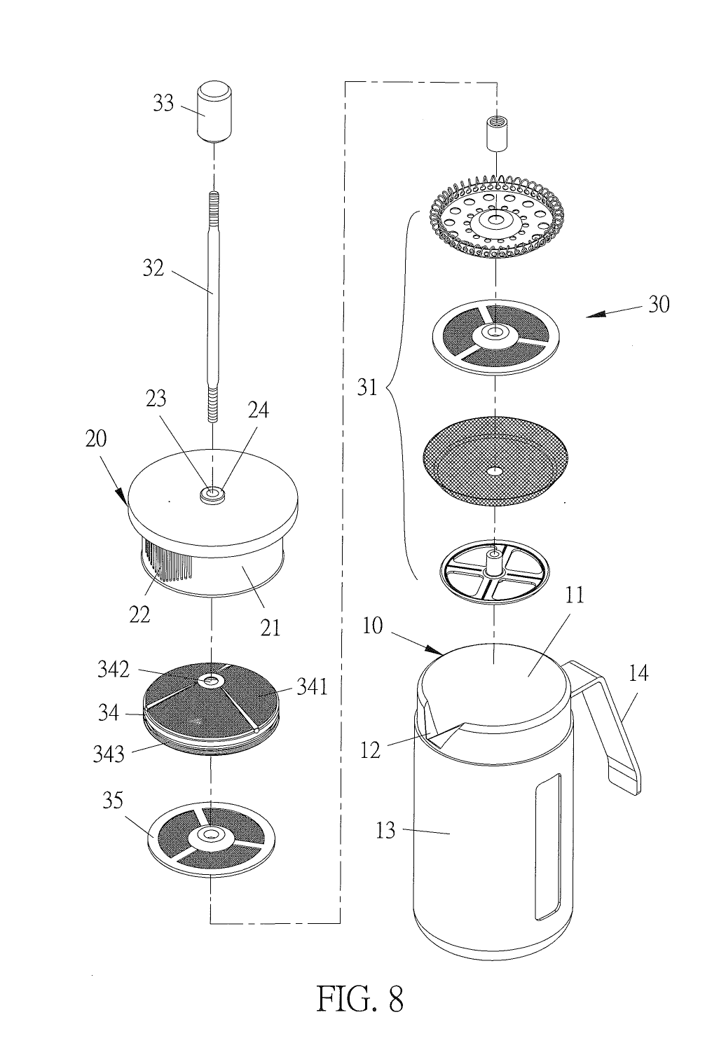

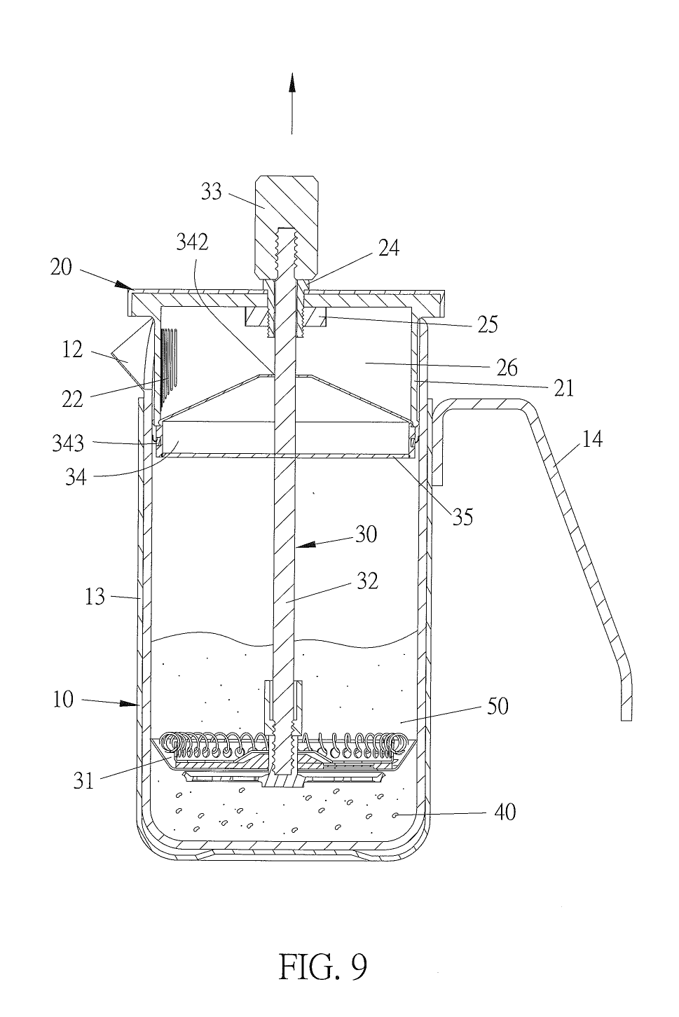

In a third embodiment, as illustrated in FIGS. 8 and 9, the second filter unit 34 includes a mesh screen unit 35 mounted on one end thereof which faces the container 10, such that the second filter unit 34 is in connection with the mesh screen 35 so as to filter the fine coffee grounds 50 or teal leaves in a multiple filtering manner, thus having brilliant filtration and maintaining normal flow speed.

Therefore, the filter kettle structure has the following advantages:

The filter kettle structure comprises the first filter unit 31 and the second filter unit 34 so that when brewing the coffee or the tea leaves, the first filter unit 31 filters the coarse coffee grounds 40 or the tea leaves, and the second filter unit 34 filters the fine coffee grounds 50 or the tea leaves, thus having brilliant filtration and taste at the normal flow speed.

While various embodiments in accordance with the present invention have been shown and described, it is clear to those skilled in the art that further embodiments may be made without departing from the scope of the present invention.

What is claimed is:

1. A filter kettle structure comprising:
a container including an opening defined on a top of the container, an outlet formed beside the opening, and a grip handle fixed on an outer wall of the container;
a lid rotatably covering the opening of the container, and the lid including a surround section extending to the container, multiple guiding holes longitudinally arranged on a peripheral wall of the surround section, and a through hole defined on a central position of the lid; and
a filtering device including a first filter unit, a connection rod, and a second filter unit;
wherein the first filter unit is housed in the container, the connection rod inserts in the through hole of the lid, and a lower end of the connection rod inserts into the container and connects with the first filter unit, hence the connection rod drives the first filter unit to move downwardly and upwardly, and an upper end of the connection rod extends out of the container;
wherein the second filter unit fits with a lower end of the surround section of the lid so that an isolation space forms in the surround section of the lid and communicates with the multiple guiding holes, the second filter unit includes an aperture defined on a central position of the second filter unit and accommodating the connection rod, and the second filter unit includes a leak-proof ring surrounding an external rim of the second filter unit and matingly contacting with an inner wall of the container.

2. The filter kettle structure as claimed in claim 1, wherein the container includes a holder fitted with the outer wall of the container, and the grip handle is fixed on the holder.

3. The filter kettle structure as claimed in claim 1, wherein the through hole of the lid accommodates a bushing, and a nut screws with the bushing.

4. The filter kettle structure as claimed in claim 1, wherein the first filter unit is in a circular disk shape, and an external rim of the first filter unit contacts with an inner wall of the container.

5. The filter kettle structure as claimed in claim 1, wherein the filtering device includes a pull cap connecting with the upper end of the connection rod.

6. The filter kettle structure as claimed in claim 1, wherein a convex part of the second filter unit is engaged with a concave part of the surround section of the lid.

7. The filter kettle structure as claimed in claim 1, wherein the second filter unit includes at least one filter mesh.

8. The filter kettle structure as claimed in claim 1, wherein the second filter unit includes a mesh screen unit mounted on one end thereof which faces the container.
